(19) United States
(12) Patent Application Publication
(10) Pub. No.: US 2012/0164341 A1
(43) Pub. Date: Jun. 28, 2012

(54) METHOD FOR REMOVING IMPURITIES FROM PLATING SOLUTIONS

(75) Inventor: Yoshiyuki HAKIRI, Agano-shi (JP)

(73) Assignee: Rohm and Haas Electronic Materials LLC, Marlborough, MA (US)

(21) Appl. No.: 13/338,483

(22) Filed: Dec. 28, 2011

(30) Foreign Application Priority Data
Dec. 28, 2010 (JP) 2010-292150

(51) Int. Cl. B05D 1/18; C23C 18/31

(52) U.S. Cl. 427/437; 106/1.22

(57) ABSTRACT

Impurities are removed from electroless tin and tin alloy plating solutions by generating precipitates through the addition of sufficient amounts of benzenesulfonic acid, benzenesulfonic acid hydrate or salts thereof to the electroless tin and tin alloy plating solutions. The precipitates may then be removed from the electroless plating solutions using conventional apparatus.

### FIELD OF THE INVENTION

The present invention is directed to a method for removing impurities from an electroless tin or tin alloy plating solution. More specifically, the present invention is directed to a method for removing impurities from an electroless tin or tin alloy plating solution by adding certain aromatic sulfonic acids to the electroless tin plating solution to generate a precipitate.

### BACKGROUND OF THE INVENTION

In recent years electroless tin plating has been used for mechanical components, flexible circuit boards and printed wiring boards, and for circuit patterns of electronic components. The electroless tin plating is often carried out as displacement tin plating on copper or copper alloys. While displacement tin plating is proceeding, displaced copper becomes copper ions dissolved in the plating solution, thus increasing the copper ions in the plating solution during plating. Accumulation of copper ions deteriorates the plating film and lowers the performance of the plating bath, thus it is required to replace the plating solution.

Conventionally known methods for control over plating solutions are the batch method and the feed-and-bleed method. The batch method is a method to renew a plating bath when the plating bath has aged. Using the batch method the plating bath must be renewed each time when the copper ion concentration increases and the bath performance decreases, thus it causes various problems such as increasing the frequency of creating new plating baths, decreasing the productivity, and increasing the costs of discarding the aged solution. The feed-and-bleed method is a method of continuous plating while the plating solution overflows. Copper ions can be removed outside of the system via the overflow without stopping the plating operations, but large amounts of plating solution must be supplemented, which entails an increase in costs.

Various techniques have been proposed as methods of resolving these problems. For example, JP05222540A discloses a method of precipitating a copper thiourea complex in the bath by cooling bath solutions that has been partially removed. The copper thiourea complex is removed through filtration and the filtrate is returned to the original plating tank. JP2002317275A discloses a method whose operations are virtually identical with those in JP05222540A. In this method the bath solution is cooled to a temperature below 40° C. to precipitate a copper thiourea complex. The copper thiourea complex is then filtered and removed.

JP10317154A discloses a method that uses a regeneration cell provided with an anode, a cathode and cation and anion exchange membrane, depositing copper on the anode in the electrolytic cell, adding tin ions passed through the cation exchange membrane into the plating solution after electroplating, then returning the solution to the plating tank. JP04276082A discloses a method of oxidation decomposition of the copper thiourea complex.

However, the methods disclosed in JP0522540A and in JP2002317275A both require cooling steps, and a cooling facility for the bath solutions must be fitted to a conventional plating apparatus. The method disclosed in JP10317154A requires an electrolytic cell for regeneration, which complicates the apparatus. The method disclosed in JP04276082A requires chemicals and equipment for oxidation decomposition of the copper thiourea complex. Accordingly, there is still a need for a method of removing impurities from a tin plating solution.

### SUMMARY OF THE INVENTION

Methods for removing impurities from an electroless tin or tin alloy plating solution include providing an electroless tin solution including one or more sources of tin ions and thiourea or thiourea compounds; and adding sufficient amounts of benzenesulfonic acid, benzenesulfonic acid hydrate or salts thereof in the electroless tin or tin alloy plating solution to generate a precipitate.

A method includes regenerating an electroless tin or tin alloy plating solution which include one or more sources of tin ions and thiourea or thiourea compounds; electrolessly plating tin on copper or copper alloy followed by adding benzenesulfonic acid, benzenesulfonic acid hydrate or salts thereof in sufficient amounts in the electroless tin or tin alloy plating solution to generate a precipitate.

A method includes forming an electroless tin or tin alloy plating film using an electroless tin or tin alloy plating solution which includes one or more sources of tin ions and thiourea or thiourea compounds; and circulating a part or all of electroless tin or tin alloy plating solution in a plating tank through a separation unit and filtrating by the separation unit a precipitate generated in the tank after adding benzenesulfonic acid, benzenesulfonic acid hydrate or salts thereof in the electroless tin or tin alloy solution.

A method also includes an electroless tin or tin alloy plating solution which includes one or more sources of tin ions and thiourea or thiourea compounds for plating a material and using a multiple tank plating device including a main tank to plate the material, a precipitation tank to generate a precipitate, circulation pipes connected between the main tank and the precipitation tank capable of circulating the electroless tin or tin alloy plating solution, and a solid-liquid separation unit placed between the precipitation tank and the main tank, where the method includes the steps of adding benzenesulfonic acid, benzenesulfonic acid hydrate or salts thereof to the electroless tin or tin alloy plating solution in the precipitation tank, and separating a solid in the solution generated in the precipitation tank using the solid-liquid separation unit.

A method further includes an electroless tin or tin alloy plating solution including one or more sources of tin ions and thiourea or thiourea compounds for plating a material using a single tank plating device which includes a plating tank to plate a material with tin or tin alloy, circulation pipes connected to the plating tank capable of circulating a part or all of the tin or tin alloy plating solution, and a solid-liquid separation unit placed in the circulation route of the plating solution, where the method includes the steps of contacting the material to be plated with the plating solution in the plating tank, adding benzenesulfonic acid, benzenesulfonic acid hydrate or salts thereof to the electroless tin or tin alloy plating solution in the plating tank, circulating the solution through the circulation pipes, and separating and removing a precipitate generated in the bath after adding benzenesulfonic acid, benzenesulfonic acid hydrate or salts thereof using the solid-liquid separation unit.

A method for control over an electroless tin or tin alloy plating solution includes providing an electroless tin or tin alloy plating solution which includes one or more sources of tin ions and thiourea or thiourea compounds for plating copper or copper alloy, where adding benzenesulfonic acid, benzenesulfonic acid hydrate or salts thereof in the electroless tin or tin alloy plating solution generates a precipitate and decreases copper ion concentration in the plating solution.

The objective of the present invention is to provide methods capable of efficiently removing impurities from electroless tin or tin alloy plating solutions without requiring separate equipment to remove impurities in the electroless tin or tin alloy plating solutions.

### BRIEF DESCRIPTION OF THE DRAWINGS

FIG. 1A is a SEM of a copper deposit prior to the addition of benzenesulfonic acid (BSA) to an electroless tin plating solution.

FIG. 1B is a SEM of a copper deposit after the addition of benzenesulfonic acid (BSA) to an electroless tin plating solution.

### DETAILED DESCRIPTION OF THE INVENTION

As used throughout this specification the following abbreviations shall have the following meanings, unless the context indicates otherwise: ° C.=degrees Centigrade, g=grams, L=liters, ml=milliliters, dm=decimeters, μm=microns or micrometers; and SEM=scanning electron micrograph. Unless otherwise specified all of the quantities are weight percent. The terms “Plating solution” and “plating bath” have the same meaning and are used interchangeably.

The inventors conducted thorough research to resolve the above problems, and found that to add benzensulfonic acid, benzenesulfonic acid hydrate or salts thereof into an electroless tin plating solution comprising thiourea or thiourea compounds, impurities in the plating bath can be removed efficiently from the bath without using specific equipment.

Impurities in electroless tin plating solutions can be efficiently removed without requiring special equipment for cooling or oxidation decomposition through the use of the method pursuant to the present invention. Furthermore, electroless tin plating solutions can be used for a prolonged period of time since plating can be continuously carried out while removing impurities, and the frequency of discarding plating solution as well as the frequency of providing a fresh plating bath can be demonstrably reduced. As a result, the present invention can contribute to great enhancement of the industrial productivity.

The target plating solution in the present invention is an electroless tin plating solution or an electroless tin alloy plating solution. The plating solutions are capable of displacement tin plating or of displacement of tin alloy plating on copper or on copper alloy. The electroless tin plating solution may contain other metals in addition to tin. The electroless tin plating solutions contain water soluble tin salts or water soluble tin salts and other metal salts as well as thiourea or thiourea compounds as complexing agents.

Any water soluble tin salts used in electroless tin plating solutions may be used in the plating solutions. Examples include stannous sulfate, stannous chloride, tin fluoroborate, tin alkanesulfonate, and tin alkanolsulfonate.

In addition, other metal salts such as salts of lead, copper, silver, bismuth and cobalt, may be used as additional metal salts that can be used with water soluble tin salts. Examples of the other metal salts include lead chloride, lead acetate, lead alkanesulfonate, copper chloride, silver nitrate, bismuth chloride, and cobalt sulfate.

The total amount of metal constituents in addition to tin and of tin in the plating solution may ranges from 10 to 100 g/L as metal, preferably from 30 to 50 g/L.

Acid may be added to the electroless tin plating solution in order to dissolve tin and metal constituents other than tin. Acids that may be used in the plating solution include sulfuric acid, hydrochloric acid, alkanesulfonic acid, alkanolsulfonic acid, and aromatic sulfonic acid. These acids may be used alone or in combinations of two or more. The amount of acid that can be added to the plating solution may range from 1 to 300 g/L, preferably from 50 to 100 g/L.

The electroless tin plating solution contains thiourea or thiourea compounds. These act as copper complexing agents. From the electrochemical perspective, these are well known to those skilled in the art as constituents that enable displacement tin plating on copper or copper alloys that are theoretically incapable of plating because of the standard electrode potential relationship. Thiourea that is readily available may be used, and commercial thiourea can be used as well.

Thiourea compounds are derivatives of thiourea. Examples include 1-methylthiourea, 1,3-dimethyl-2-thiourea, trimethylthiourea, diethylthiourea, N,N-diisopropyl thiourea, 1-(3-hydroxypropyl)-2-thiourea, 1-methyl-3-(3-hydroxypropyl)-2-thiourea, 1-methyl-3-(3-methoxypropyl)-2-thiourea, 1,3-bis (3-hydroxypropyl)-2-thiourea, allyl thiourea, 1-acetyl-2-thiourea, 1-phenyl-3-(2-thiazolyl)thiourea, benzyl isothiourea hydrochloride, 1-allyl-2-thiourea, and 1-benzoyl-2-thiourea. These thioureas or thiourea compounds may be used alone or in combinations of two or more. The amount of use of these thioureas or thiourea compounds may be in a range of 50 to 250 g/L, preferably a range of 100 to 200 g/L.

Electroless tin plating solution may contain antioxidants, surfactants and other additives as required in addition to aforementioned constituents. Examples of antioxidants that can be used include catechol, hydroquinone and hypophosphorous acid. Examples of surfactants include one, two or more cationic, anionic, nonionic and amphoteric surfactants.

Displacement tin plating or electroless tin plating is usually carried out by preparing the plating solution, setting the temperature to a range of 50 to 75° C., and immersing material to be plated with copper or copper alloy on the surface in the plating solution for 120 to 300 seconds. The tin displaces the copper on the surface of material to be plated to form a tin film while the copper dissolves in the plating solution. Consequently, tin concentration in the plating solution decreases as plating proceeds. Furthermore, while not being bound by theory, the thiourea or thiourea compounds that are complexing agents are believed to form complexes with copper in the plating solution such that these thiourea or thiourea compounds also decrease as plating proceeds. Moreover, acid and other constituents decrease as the material to be plated is hoisted or pumped out, and they also decrease as plating proceeds. These constituents that decrease in the plating solution as plating proceeds are appropriately supplemented. However, copper increases as plating proceeds and its accumulation in the plating bath leads to deterioration of the plating film and a decline in the bath performance.

The present invention is characterized by the addition of benzenesulfonic acid, benzenesulfonic acid hydrate or salts thereof (hereinafter termed benzenesulfonic acid) to electroless tin plating solution in order to create a precipitate containing copper that inhibits the accumulation of copper in the plating solution. The concentration of copper ions in the plating solution can be reduced by adding benzenesulfonic acid to the plating solution because copper ion complexes dissolve in the plating solution precipitate. The method pursuant to the present invention is far superior to conventional technology in that the temperature of the plating solution need not be lowered when creating a precipitate. While the specific reaction mechanism remains unclear, copper ions in the plating solution are believed to be found as complexes of thiourea or thiourea compounds, and the solubility of complexes of thiourea or thiourea compounds is lowered through the addition of benzenesulfonic acid, thereby resulting in the formation of precipitate without requiring a cooling operation.

Examples of benzenesulfonic acid hydrates include benzenesulfonic acid 1-hydrate, benzenesulfonic acid 1.5-hydrate, and benzenesulfonic acid 2-hydrate. Various salts of benzenesulfonic acid and of benzenesulfonic acid hydrate are permissible. Concrete examples include sodium salts, potassium salts, and ammonium salts. Commercial benzenesulfonic acid may also be used. Mixtures of benzenesulfonic acid, benzenesulfonic acid hydrate or salts thereof may also be used, and the amount used are in the range of 5 to 200 g/L, preferably 20 to 100 g/L, more preferably 50 to 100 g/L. Precipitate does not form if the amount used is too low. An amount exceeding 20 g/L should be used in order to attain adequate precipitation. If the amount used is excessive, the tin precipitation state deteriorates and the bath performance is impaired, such as decline in the precipitation speed.

A first method is a method for removing impurities from an electroless tin plating solution which includes one or more sources of tin ions and thiourea or thiourea compounds, and adding benzenesulfonic acid, benzenesulfonic acid hydrate or salts thereof in the plating solution to generate a precipitate. Here, the electroless tin plating solution to which benzenesulfonic acid is added preferably is a solution that has already been used in electroless tin plating. In this case, if the solution is a plating solution that has already been used in electroless tin plating, either plating solution in which electroless tin plating treatment has been completed or solution whose electroless tin plating treatment is underway may be used. The impurities may be copper or other metals, such as nickel, zinc, chromium, molybdenum, and tungsten that had dissolved from the material to be plated. The impurity is usually copper, and copper can be effectively removed from plating solution. Insoluble constituents containing copper precipitate when benzenesulfonic acid is added to the used plating solution in which the copper concentration has increased. Copper can be removed from the plating solution by removing such insoluble constituents. Various methods of removing insoluble constituents may be used, including filtration using a filter, precipitation separation, and centrifugal separation.

The second method is a method for regenerating an electroless tin plating solution which includes one or more sources of tin ions and thiourea or thiourea compounds, and adding benzenesulfonic acid, benzenesulfonic acid hydrate or salts thereof in the plating solution to generate a precipitate after conducting electroless plating on copper or copper-alloy by using the plating solution, then removing the precipitate from the solution. As stated above, impurities, especially copper, can be removed from the plating solution through removal of precipitates by adding benzenesulfonic acid. The electroless tin plating solution can be reused following precipitate removal. The plating solution can be continuously used by supplementing other constituents that had been consumed or reduced in quantity. As a result, older plating solutions need not be discarded, which contributes to enhanced industrial productivity.

A third method is a method for forming a tin plating film using an electroless tin plating solution which includes one or more sources of tin ions and thiourea or thiourea compounds and circulating a part or all of the plating solution in a plating tank through a separation unit and filtrating using the separation unit a precipitate generated in the tank after adding benzenesulfonic acid, benzenesulfonic acid hydrate or salts thereof in the solution. In this method, the circulation of electroless tin plating solution may be carried out while plating continues, or it may be carried out as the plating operation is temporarily suspended. The addition of benzenesulfonic acid in the course of formation of plating film does not affect the characteristics of the plating film as long as the amount of plating solution in the plating tank is adequate. The fact that the plating operation need not be stopped during the addition of benzenesulfonic acid in the course of formation of a plating film as plating is continued or in the course of circulation of plating solution is desirable from the perspective of productivity. Any solid-liquid separation unit may be used as long as it is capable of separating precipitate that formed from plating solution. Filtration using a filter, precipitation separation, or centrifugal separation unit may be used. Here, the addition of benzenesulfonic acid to the plating solution that had deteriorated due to continuation of plating is preferably carried out in the course of plating. The benzenesulfonic acid preferably is added to plating solution in which metal ions such as copper, nickel, zinc, chromium, molybdenum or tungsten have dissolved from the material to be plated, resulting in a decline in the bath performance. As mentioned above, the electroless tin plating solution is prepared and the formation of the plating film is carried out by adjusting the temperature of the plating solution to a temperature in the range of 50 to 75° C., followed by immersing in the plating solution the material to be plated that has copper or copper alloy on the surface for 120 to 300 seconds. Since copper ions dissolve in the plating solution as plating proceeds, the addition of benzenesulfonic acid, the circulation of plating solution and the removal of the precipitate should be carried out at the necessary timing. Furthermore, constituents in the plating solution that have been consumed or diminished may be appropriately supplemented.

The fourth method is a method for electroless tin plating using a tin plating solution which includes one or more sources of tin ions and thiourea or thiourea compounds with use of a multiple tank plating device which includes a main tank to plate the material, a precipitation tank to generate a precipitate, circulation pipes connected between the main tank and the precipitation tank capable of circulating the electroless tin plating solution, and a solid-liquid separation unit placed between the precipitation tank and the main tank, the method includes the steps of adding benzenesulfonic acid, benzenesulfonic acid hydrate or salts thereof to the plating solution in the precipitation tank, and separating a solid in the solution generated in the precipitation tank using the solid-liquid separation unit. This fourth method pursuant to the present invention is characterized by the use of a multiple tank plating device furnished with a precipitation tank in order to form precipitates in addition to the main tank in which electroless plating is carried out. A minimum of two tanks are required, but three or more tanks may be used as needed. The main tank and the precipitation tank may be of any size and shape so long as they permit plating treatment and precipitate formation. The main tank and the precipitation tank are connected by piping to enable circulation of electroless plating solution between the two. The piping may be of any configuration as long as it permits circulation of plating solution. In addition, a solid-liquid separation unit may be placed between the precipitation tank and the main tank, and the precipitate that formed due to the addition of benzenesulfonic acid may then be separated. As indicated above, any type of solid-liquid separation unit may be used.

Benzenesulfonic acid is added to the electroless tin plating solution in the precipitation tank in the first step. Benzenesulfonic acid may be added in the course of circulation of plating solution or benzenesulfonic acid may be added upon suspension of plating solution circulation. Furthermore, the plating operation in the main tank may be continued when adding benzenesulfonic acid or the plating operation may be temporarily suspended. The addition of benzenesulfonic acid while continuing the plating operation is preferable from the perspective of productivity since plating need not be suspended. Furthermore, the temperature of the plating solution in the main tank should be in the range of 50 to 70° C., and the temperature of the plating solution in the precipitation tank may be the same temperature as that of the plating solution in the main tank or it preferably is in a range 10° C. above or below the liquid temperature in the main tank. Temperature control for regulating the temperature of the plating solution that has been returned to the main tank from the precipitation tank to regulate it to a temperature suitable for plating is facilitated by setting the temperature of the plating solution in the precipitation tank in this range. The method of capture of the precipitate that had been formed using the solid-liquid separation unit in the second step is as stated previously.

The fifth method is a method for electroless plating of material using an electroless tin plating solution which includes one or more tin ions and thiourea or thiourea compounds with use of a single tank plating device including a plating tank to plate a material, circulation pipes connected to the plating tank capable of circulating a part or all of the plating solution, and a solid-liquid separation unit placed in the circulation route of the plating solution, where the method includes the steps of contacting the material to be plated with the plating solution in the plating tank, adding benzenesulfonic acid, benzenesulfonic acid hydrate or salts thereof to the plating solution in the plating tank, circulating the solution through the circulation pipes, and separating and removing a precipitate generated in the bath after adding benzenesulfonic acid, benzenesulfonic acid hydrate or salts thereof using the solid-liquid separation unit. This fifth method is characterized by the use of a single tank type of plating device for adding benzenesulfonic acid to a plating tank in which electroless plating is carried out to generate precipitate. The plating tank has a size and shape sufficient for plating treatment and for precipitate generation, but the use of a large-capacity tank is preferable to the use of a multiple tank type of device when both operations are carried out concurrently. The circulation piping and the solid-liquid separation unit may have a variety of configurations as mentioned above.

In the first step, the material to be plated is immersed in plating solution in a plating tank and displacement plating is carried out. The temperature of the plating solution in the plating tank should be in the range of 50 to 75° C. Copper ions that dissolved in the plating tank from the material to be plated accumulate as displacement plating proceeds in the plating tank. In the second step, benzenesulfonic acid is added to the plating solution in the plating tank. When benzenesulfonic acid is added in the fifth method, the plating operation may be continued in the plating tank or the plating operation may be temporarily suspended. The addition of benzenesulfonic acid while continuing the plating operation is preferable from the perspective of productivity since plating need not be suspended. In the third step, the precipitate generated in the plating tank is fed to the solid-liquid separation unit via the circulation piping where it is separated from the plating solution and removed. The circulation of plating solution must be conducted at least after the addition of benzenesulfonic acid. Furthermore, if aforementioned first to third steps are initiated in sequence, a subsequent step may be carried out without waiting for completion of the preceding step. For example, once material to be plated has been immersed in the plating solution in the plating tank in the first step, benzenesulfonic acid addition, which constitutes the second step, may be carried out even while the immersion of material to be plated is continued.

The sixth method is a method for control over an electroless tin plating solution, the electroless tin solution includes one or more sources of tin ions and thiourea or thiourea compounds for plating copper or copper alloy, and adding benzenesulfonic acid, benzenesulfonic acid hydrate or salts thereof in the plating solution to generate a precipitate and decreasing a concentration of copper ion in the plating solution. The concentration of copper ions in the plating solution is measured in aforementioned plating tanks that have various configurations. Benzenesulfonic acid is then added to the plating solution at the appropriate moment before the copper concentration reaches the upper limit at which plating would be adversely affected, and the copper ion concentration in plating solution is reduced through the generation of precipitate. Thus, electroless plating solution can be maintained in the most appropriate condition. Measurement of the copper ions in the plating solution may be carried out by any conventional method. For example, part of the plating solution may be sampled for measurement of the copper ion concentration via atomic absorption analysis or ICP.

The following examples are not intended to limit the scope of the invention but are included to further illustrate the invention.

### Example 1

Electroless tin plating solution (basic bath 1) having the following composition was prepared.

### Basic Bath 1

Tin fluoroborate (as Sn²) 30 g/L
Methanesulfonic acid 50 g/L
Hypophosphorous acid 15 g/L

### Thiourea 100 g/L

Nonionic surfactant 30 g/L

A total of 15 g/L of copper powder was added to aforementioned tin plating solution, followed by heating for five hours at 65° C. under stirring to complete a displacement reaction between copper and tin. The creation of electroless tin plating solution containing copper ions that had suffered deterioration was simulated. While the aforementioned simulated electroless tin plating solution that had deteriorated was held at 65° C., 30 g/L of benzenesulfonic acid was added to the plating solution. Following the addition of benzenesulfonic acid, suspended material was generated in the plating solution. The suspended material precipitated while the plating solution was held at 65° C., and the supernatant that was then sampled was subjected to measurement of the copper concentration via atomic absorption analysis. The copper concentration that was measured was 9.5 g/L.

### Example 2

The same operations as in Example 1 were repeated except for the addition of 60 g/L of benzenesulfonic acid to aforementioned basic bath 1, after which the copper concentration was measured. The copper concentration was measured to be 6.6 g/L.

### Comparative Examples 1 to 5

The same operations as in Example 1 were repeated except for omitting benzenesulfonic acid addition to aforementioned basic bath 1 (Comparative Example 1) or adding 30 g/L of the compounds presented in Table 1, (Comparative Examples 2 to 5). Table 1 presents the results.

The copper concentration was measured only in Comparative Example 1 since no precipitate settled in any of Comparative Examples 1 to 5.

TABLE 1

| | | Amount | Presence | Copper |
|---|---|---|---|---|
| | | added | of | concentration |
| Example No. | Precipitant | (g/L) | precipitate | (g/L) |
| Example 1 | Benzenesulfonic | 30 | Present | 9.5 |
| | acid | | | |
| Example 2 | Benzenesulfonic | 60 | Present | 6.6 |
| | acid | | | |
| Comparative | None | — | Absent | 14.7 |
| Example 1 | | | | |
| Comparative | Paratoluene sulfonic | 30 | Absent | — |
| Example 2 | acid | | | |
| Comparative | Naphthane sulfonic | 30 | Absent | — |
| Example 3 | acid | | | |
| Comparative | Benzene carboxylic | 30 | Absent | — |
| Example 4 | acid | | | |
| Comparative | Salicylic acid | 30 | Absent | — |
| Example 5 | | | | |

Aforementioned results indicate that the copper concentration in plating decreased as a result of the generation of precipitate upon the addition of benzenesulfonic acid.

### Examples 3, 4 and Comparative Example 6

Electroless tin plating solution having the following composition was prepared by modifying the composition of the plating bath from that in Example 1 (Basic Bath 2).

### Basic Bath 2

Tin methanesulfonate (as Sn²⁺) 30 g/L
Methanesulfonic acid 50 g/L
Hypophosphorous acid 15 g/L

### Thiourea 100 g/L

Nonionic surfactant 30 g/L

The same operations as in Example 1 were repeated except for the addition to aforementioned basic bath 2 of benzenesulfonic acid in the quantities shown in Table 2, after which the copper concentration in the plating solution was measured. Table 2 shows the results.

TABLE 2

| | | Amount | Presence | Copper |
|---|---|---|---|---|
| | | added | of | concentration |
| Example No. | Precipitant | (g/L) | precipitate | (g/L) |
| Example 3 | Benzenesulfonic | 30 | Present | 10.6 |
| | acid | | | |
| Example 4 | Benzenesulfonic | 60 | Present | 6.3 |
| | acid | | | |
| Comparative | None | — | Absent | 14.2 |
| Example 6 | | | | |

Aforementioned results indicate that the copper concentration in plating decreased as a result of the generation of precipitate upon the addition of benzenesulfonic acid even if the composition of the plating solution has been altered.

### Examples 5 and 6

Performance confirmation tests on plating solution were conducted following the removal of impurities through the addition of benzenesulfonic acid. Basic bath 1 used in Example 1 was prepared as the plating bath.

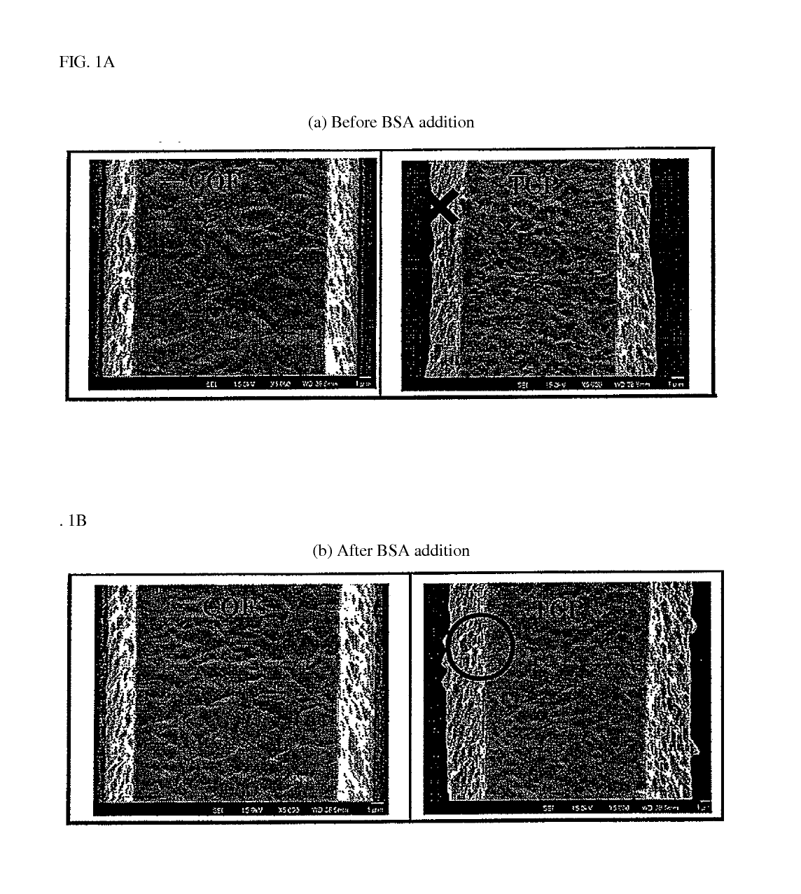

The preparation of an electroless tin plating solution containing copper ions that had undergone deterioration following completion of a displacement reaction of copper and tin through the addition of 7 g/L (Example 5) and 10 g/L (Example 6) of copper powder to basic bath 1, followed by heating for five hours, was simulated. Tin fluoroborate was added to aforementioned simulated, deteriorated, electroless tin plating solution in order to supplement the tin that had decreased due to displacement with copper, and the tin concentration was adjusted to 30 g/L. Displacement tin plating was carried out on material to be plated (TCP and COF in which pattern formation had been completed) for three minutes, fifteen seconds at 65° C. using this plating solution, and SEM observation as well as film thickness measurement were completed. To aforementioned plating solution was added either 28 g/L (Example 5) or 40 g/L (Example 6) of benzenesulfonic acid, followed by adequate stirring, filtration, and removal of the precipitate that formed. Displacement plating was carried out using those baths following removal of the precipitate. SEM observations as well as film thickness measurement were completed, and the state was compared with that preceding the addition of benzenesulfonic acid (BSA). Table 3 presents the results. In addition, FIGS. 1A-B illustrate the SEM photographs before and after the addition of benzenesulfonic acid in Example 6. COF denotes “Chip on Film” while TCP denotes “Tape Carrier Package”. Table 3 shows confirmation of decline in the copper concentration as well as improvement in the film thickness. Furthermore, improvement of the crystalline state was confirmed through FIG. 1B.

TABLE 3

| | Before BSA addition | | After BSA addition | |
|---|---|---|---|---|
| | Copper | Plating film | Copper | Plating film |
| | concentra- | thickness | concentra- | thickness |
| Example No. | tion (g/L) | (μm) | tion (g/L) | (μm) |
| Example 5 | 6.7 | 0.49 | 0.5 | 0.51 |
| Example 6 | 9.8 | 0.44 | 0.2 | 0.52 |

Recovery of the bath performance (recovery of the precipitation speed) through removal of copper using benzenesulfonic acid was confirmed in Examples 5 and 6.

What is claimed is:

1. A method for removing impurities from an electroless tin or tin alloy plating solution comprising:
a) providing a solution comprising one or more sources of tin ions and thiourea or thiourea compounds; and
b) adding sufficient amounts of benzenesulfonic acid, benzenesulfonic acid hydrate or salts thereof in solution to generate a precipitate.

2. The method of claim 1, further comprising plating a tin or tin alloy layer on copper or copper alloy.

3. The method of claim 2, wherein the benzenesulfonic acid, benzenesulfonic acid hydrate or salts thereof are added to the solution after electroless plating on copper and copper alloy.

4. The method of claim 3, wherein a temperature of the solution is 10° C. above or below a plating temperature when the benzenesulfonic acid, benzenesulfonic acid hydrate or salts thereof are added to the solution.

5. The method of claim 1, wherein the benzenesulfonic acid, benzenesulfonic acid hydrate or salts thereof are included in the solution in amounts of 5 to 200 g/L.

6. The method of claim 5, wherein the benzenesulfonic acid, benzenesulfonic acid hydrate or salts thereof are added in the solution in amounts of 20 to 100 g/L.

7. The method of claim 6, wherein the benzensulfonic acid, benzene sulfonic acid hydrate or salts thereof are added in the solution in amounts of 50 to 100 g/L.

8. The method of claim 1, wherein the precipitate comprises copper, nickel, zinc, chromium, molybdenum or tungsten.
